(19) United States
(12) Patent Application Publication
(10) Pub. No.: US 2017/0102771 A1
(43) Pub. Date: Apr. 13, 2017

(54) WEARABLE ULTRASONIC HAPTIC FEEDBACK SYSTEM

(71) Applicant: Na LEI, Shenzhen (CN)

(72) Inventor: Na LEI, Shenzhen (CN)

(73) Assignee: LEIBS TECHNOLOGY LIMITED, Hong Kong (HK)

(21) Appl. No.: 15/375,185

(22) Filed: Dec. 12, 2016

(51) Int. Cl. G06F 3/01; G06F 3/041; G06F 3/043

(52) U.S. Cl. CPC G06F 3/016; G06F 3/0436; G06F 3/0418

(57) ABSTRACT

A wearable ultrasonic haptic feedback system includes: a substrate layer; an ultrasonic transmitter matrix layer disposed above the substrate layer and including a plurality of ultrasonic transmitters; a converter matrix layer disposed below the substrate layer and including a plurality of converters; a first control unit connected with the ultrasonic transmitter matrix layer; an RF receiver connected with the first control unit; a second control unit connected with the converter matrix layer; and an RF transmitter connected with the second control unit. The ultrasonic transmitters are configured to be controlled by the first control unit to transmit an ultrasonic signal of a preset frequency respectively. The converters are configured to be respectively controlled by the second control unit to sense an ultrasonic signal and convert the sensed ultrasonic signal to an electrical signal. The RF transmitter is configured to transmit the electrical signal through an RF signal of a preset frequency. The RF receiver is configured to receive the RF signal transmitted by the RF transmitter and restore the electrical signal from the RF signal.

### FIELD OF THE PATENT APPLICATION

The present patent application generally relates to human machine interaction technologies and more specifically to a wearable ultrasonic haptic feedback system.

### BACKGROUND

Conventional human machine interaction (HMI) systems typically rely on vision sensing to realize feedback. For example, when using conventional screen display or touch display, the user relies on vision to capture an instruction or confirmation mark on the screen and to determine the next operation based on the mark. However, in many situations, visual feedback cannot satisfy the requirements of specific application. For example, when driving a vehicle, if the driver relies on his vision to operate a GPS navigation system, his sight will move to the screen from the road, which constitutes a potential safety hazard. For another example, under strong light, a user may find it very difficult to read the content being displayed on a display. For a person with vision disorder, it would not be possible to use feedback based on vision even under a normal lighting condition. On the other hand, as an important basis for human machine interaction, a sensing feedback system is required to have sufficiently high accuracy and resolution in many application scenarios. The applications of some existing feedback systems that do not rely on vision feedback are limited because of the relatively low accuracy and resolution. Therefore, it is desired to provide a sense feedback system that does not rely on vision but has relatively high accuracy and resolution so as to meet requirements of human machine interaction in various application scenarios.

### SUMMARY

The present patent application is directed to a wearable ultrasonic haptic feedback system. In one aspect, the wearable ultrasonic haptic feedback system includes: a substrate layer; an ultrasonic transmitter matrix layer disposed above the substrate layer and including a plurality of ultrasonic transmitters; a first adhesive layer disposed between the ultrasonic transmitter matrix layer and the substrate layer and configured to make the ultrasonic transmitter matrix layer adhere to the substrate layer; a converter matrix layer disposed below the substrate layer and including a plurality of converters; a second adhesive layer disposed between the substrate layer and the converter matrix layer and configured to make the substrate layer adhere to the converter matrix layer; a first control unit connected with the ultrasonic transmitter matrix layer; an RF receiver connected with the first control unit; a second control unit connected with the converter matrix layer; an RF transmitter connected with the second control unit; a cover layer covering outside of the ultrasonic transmitter matrix layer and the converter matrix layer, the RF transmitter and the RF receiver being respectively disposed at surface of the converter matrix layer and surface of the ultrasonic transmitter matrix layer, and sealed by the cover layer, the cover layer being made of a material capable of shielding EMI; and a display device connected with the first control unit and configured to display signal strength of signals received by the RF receiver. Thickness of the converter matrix layer is less than thickness of the ultrasonic transmitter matrix layer. The ultrasonic transmitters are configured to be controlled by the first control unit to transmit an ultrasonic signal of a preset frequency respectively. The converters are configured to be respectively controlled by the second control unit to sense an ultrasonic signal and convert the sensed ultrasonic signal to an electrical signal. The RF transmitter is configured to transmit the electrical signal through an RF signal of a preset frequency. The RF receiver is configured to receive the RF signal transmitted by the RF transmitter and restore the electrical signal from the RF signal. The second control unit is configured to select any converter in the converter matrix layer as a selected converter. The first control unit is configured to sequentially control each ultrasonic transmitter in the ultrasonic transmitter matrix layer to transmit a calibrating ultrasonic signal. The calibrating ultrasonic signal is transmitted to the selected converter and sensed thereby so as to produce a sensing electrical signal. The sensing electrical signal is controlled by the second control unit, transmitted by the RF transmitter in form of an RF signal, and received by the RF receiver. The first control unit is configured to perform a time reversal transformation on the sensing electrical signal received by the RF receiver and store an electrical signal waveform resulted from the transformation. After the transformed electrical signal waveforms corresponding to all ultrasonic transmitters of the ultrasonic transmitter matrix layer are stored in the first control unit, the first control unit is configured to drive the ultrasonic transmitters simultaneously with the stored electrical signal waveforms that correspond to the ultrasonic transmitters respectively, so that ultrasonic waves transmitted by the ultrasonic transmitters are focused at the selected converter s location, thereby generating haptic stimulation to a user. When the signal strength displayed by the display device is lower than a preset threshold, the first control unit is configured to again sequentially control each ultrasonic transmitter in the ultrasonic transmitter matrix layer to transmit a calibrating ultrasonic signal. The calibrating ultrasonic signal is transmitted to the selected converter and sensed thereby so as to produce a sensing electrical signal. The sensing electrical signal is controlled by the second control unit, transmitted by the RF transmitter in form of an RF signal, and received by the RF receiver. The first control unit is configured to perform a time reversal transformation on the sensing electrical signal received by the RF receiver and store an electrical signal waveform resulted from the transformation.

In another aspect, the present patent application provides a wearable ultrasonic haptic feedback system that includes: a substrate layer; an ultrasonic transmitter matrix layer disposed above the substrate layer and including a plurality of ultrasonic transmitters; a converter matrix layer disposed below the substrate layer and including a plurality of converters; a first control unit connected with the ultrasonic transmitter matrix layer; an RF receiver connected with the first control unit; a second control unit connected with the converter matrix layer; and an RF transmitter connected with the second control unit. The ultrasonic transmitters are configured to be controlled by the first control unit to transmit an ultrasonic signal of a preset frequency respectively. The converters are configured to be respectively controlled by the second control unit to sense an ultrasonic signal and convert the sensed ultrasonic signal to an electrical signal. The RF transmitter is configured to transmit the electrical signal through an RF signal of a preset frequency. The RF receiver is configured to receive the RF signal transmitted by the RF transmitter and restore the electrical signal from the RF signal. The second control unit is configured to select any converter in the converter matrix layer as a selected converter. The first control unit is configured to sequentially control each ultrasonic transmitter in the ultrasonic transmitter matrix layer to transmit a calibrating ultrasonic signal. The calibrating ultrasonic signal is transmitted to the selected converter and sensed thereby so as to produce a sensing electrical signal. The sensing electrical signal is controlled by the second control unit, transmitted by the RF transmitter in form of an RF signal, and received by the RF receiver. The first control unit is configured to perform a time reversal transformation on the sensing electrical signal received by the RF receiver and store an electrical signal waveform resulted from the transformation. After the transformed electrical signal waveforms corresponding to all ultrasonic transmitters of the ultrasonic transmitter matrix layer are stored in the first control unit, the first control unit is configured to drive the ultrasonic transmitters simultaneously with the stored electrical signal waveforms that correspond to the ultrasonic transmitters respectively, so that ultrasonic waves transmitted by the ultrasonic transmitters are focused at the selected converter s location, thereby generating haptic stimulation to a user.

Thickness of the converter matrix layer may be less than thickness of the ultrasonic transmitter matrix layer. The calibrating ultrasonic signals being used for different ultrasonic transmitters may have the same strength. The calibrating ultrasonic signals being used for different ultrasonic transmitters may have different strengths.

The wearable ultrasonic haptic feedback system may further include a display device connected with the first control unit and configured to display signal strength of signals received by the RF receiver. When the signal strength displayed by the display device is lower than a preset threshold, the first control unit may be configured to again sequentially control each ultrasonic transmitter in the ultrasonic transmitter matrix layer to transmit a calibrating ultrasonic signal. The calibrating ultrasonic signal may be transmitted to the selected converter and sensed thereby so as to produce a sensing electrical signal. The sensing electrical signal may be controlled by the second control unit, transmitted by the RF transmitter in form of an RF signal, and received by the RF receiver. The first control unit may be configured to perform a time reversal transformation on the sensing electrical signal received by the RF receiver and store an electrical signal waveform resulted from the transformation.

When strength of signal received by the RF receiver is lower than a preset threshold, the first control unit may be configured to again sequentially control each ultrasonic transmitter in the ultrasonic transmitter matrix layer to transmit a calibrating ultrasonic signal. The calibrating ultrasonic signal may be transmitted to the selected converter and sensed thereby so as to produce a sensing electrical signal. The sensing electrical signal may be controlled by the second control unit, transmitted by the RF transmitter in form of an RF signal, and received by the RF receiver. The first control unit may be configured to perform a time reversal transformation on the sensing electrical signal received by the RF receiver and store an electrical signal waveform resulted from the transformation.

The wearable ultrasonic haptic feedback system may further include a first adhesive layer and a second adhesive layer. The substrate layer may be made of a textile material with a certain thickness and structural strength. The first adhesive layer may be disposed between the ultrasonic transmitter matrix layer and the substrate layer and configured to make the ultrasonic transmitter matrix layer adhere to the substrate layer. The second adhesive layer may be disposed between the substrate layer and the converter matrix layer and configured to make the substrate layer adhere to the converter matrix layer.

The wearable ultrasonic haptic feedback system may further include a cover layer covering outside of the ultrasonic transmitter matrix layer and the converter matrix layer. The RF transmitter and the RF receiver may be respectively disposed at surface of the converter matrix layer and surface of the ultrasonic transmitter matrix layer, and sealed by the cover layer. The cover layer may be made of a material capable of shielding EMI.

In yet another aspect, the present patent application provides a wearable ultrasonic haptic feedback system that includes: a substrate layer; an ultrasonic transmitter matrix layer disposed above the substrate layer and including a plurality of ultrasonic transmitters; a converter matrix layer disposed below the substrate layer and including a plurality of converters; a first control unit connected with the ultrasonic transmitter matrix layer; an RF receiver connected with the first control unit; a second control unit connected with the converter matrix layer; and an RF transmitter connected with the second control unit. The ultrasonic transmitters are configured to be controlled by the first control unit to transmit an ultrasonic signal of a preset frequency respectively. The converters are configured to be respectively controlled by the second control unit to sense an ultrasonic signal and convert the sensed ultrasonic signal to an electrical signal. The RF transmitter is configured to transmit the electrical signal through an RF signal of a preset frequency. The RF receiver is configured to receive the RF signal transmitted by the RF transmitter and restore the electrical signal from the RF signal.

The second control unit may be configured to select any converter in the converter matrix layer as a selected converter. The first control unit may be configured to sequentially control each ultrasonic transmitter in the ultrasonic transmitter matrix layer to transmit a calibrating ultrasonic signal. The calibrating ultrasonic signal may be transmitted to the selected converter and sensed thereby so as to produce a sensing electrical signal. The sensing electrical signal may be controlled by the second control unit, transmitted by the RF transmitter in form of an RF signal, and received by the RF receiver. The first control unit may be configured to perform a time reversal transformation on the sensing electrical signal received by the RF receiver and store an electrical signal waveform resulted from the transformation.

After the transformed electrical signal waveforms corresponding to all ultrasonic transmitters of the ultrasonic transmitter matrix layer are stored in the first control unit, the first control unit may be configured to drive the ultrasonic transmitters simultaneously with the stored electrical signal waveforms that correspond to the ultrasonic transmitters respectively, so that ultrasonic waves transmitted by the ultrasonic transmitters are focused at the selected converter s location, thereby generating haptic stimulation to a user. Thickness of the converter matrix layer may be less than thickness of the ultrasonic transmitter matrix layer. The calibrating ultrasonic signals being used for different ultrasonic transmitters may have the same strength.

The calibrating ultrasonic signals being used for different ultrasonic transmitters may have different strengths.

The wearable ultrasonic haptic feedback system may further include a display device connected with the first control unit and configured to display signal strength of signals received by the RF receiver. When the signal strength displayed by the display device is lower than a preset threshold, the first control unit may be configured to again sequentially control each ultrasonic transmitter in the ultrasonic transmitter matrix layer to transmit a calibrating ultrasonic signal. The calibrating ultrasonic signal may be transmitted to the selected converter and sensed thereby so as to produce a sensing electrical signal. The sensing electrical signal may be controlled by the second control unit, transmitted by the RF transmitter in form of an RF signal, and received by the RF receiver. The first control unit may be configured to perform a time reversal transformation on the sensing electrical signal received by the RF receiver and store an electrical signal waveform resulted from the transformation.

When strength of signal received by the RF receiver is lower than a preset threshold, the first control unit may be configured to again sequentially control each ultrasonic transmitter in the ultrasonic transmitter matrix layer to transmit a calibrating ultrasonic signal. The calibrating ultrasonic signal may be transmitted to the selected converter and sensed thereby so as to produce a sensing electrical signal. The sensing electrical signal may be controlled by the second control unit, transmitted by the RF transmitter in form of an RF signal, and received by the RF receiver. The first control unit may be configured to perform a time reversal transformation on the sensing electrical signal received by the RF receiver and store an electrical signal waveform resulted from the transformation.

The wearable ultrasonic haptic feedback system may further include a first adhesive layer and a second adhesive layer. The substrate layer may be made of a textile material with a certain thickness and structural strength. The first adhesive layer may be disposed between the ultrasonic transmitter matrix layer and the substrate layer and configured to make the ultrasonic transmitter matrix layer adhere to the substrate layer. The second adhesive layer may be disposed between the substrate layer and the converter matrix layer and configured to make the substrate layer adhere to the converter matrix layer.

The wearable ultrasonic haptic feedback system may further include a cover layer covering outside of the ultrasonic transmitter matrix layer and the converter matrix layer. The RF transmitter and the RF receiver may be respectively disposed at surface of the converter matrix layer and surface of the ultrasonic transmitter matrix layer, and sealed by the cover layer. The cover layer may be made of a material capable of shielding EMI.

Thickness of the converter matrix layer may be less than thickness of the ultrasonic transmitter matrix layer.

### BRIEF DESCRIPTION OF THE DRAWINGS

FIG. 1 is a block diagram of a wearable ultrasonic haptic feedback system in accordance with an embodiment of the present patent application.

FIG. 2 illustrates an ultrasonic transmitter matrix layer of the wearable ultrasonic haptic feedback system depicted in FIG. 1.

FIG. 3 illustrates a converter matrix layer of the wearable ultrasonic haptic feedback system depicted in FIG. 1.

### DETAILED DESCRIPTION

Reference will now be made in detail to a preferred embodiment of the wearable ultrasonic haptic feedback system disclosed in the present patent application, examples of which are also provided in the following description. Exemplary embodiments of the wearable ultrasonic haptic feedback system disclosed in the present patent application are described in detail, although it will be apparent to those skilled in the relevant art that some features that are not particularly important to an understanding of the wearable ultrasonic haptic feedback system may not be shown for the sake of clarity.

Furthermore, it should be understood that the wearable ultrasonic haptic feedback system disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

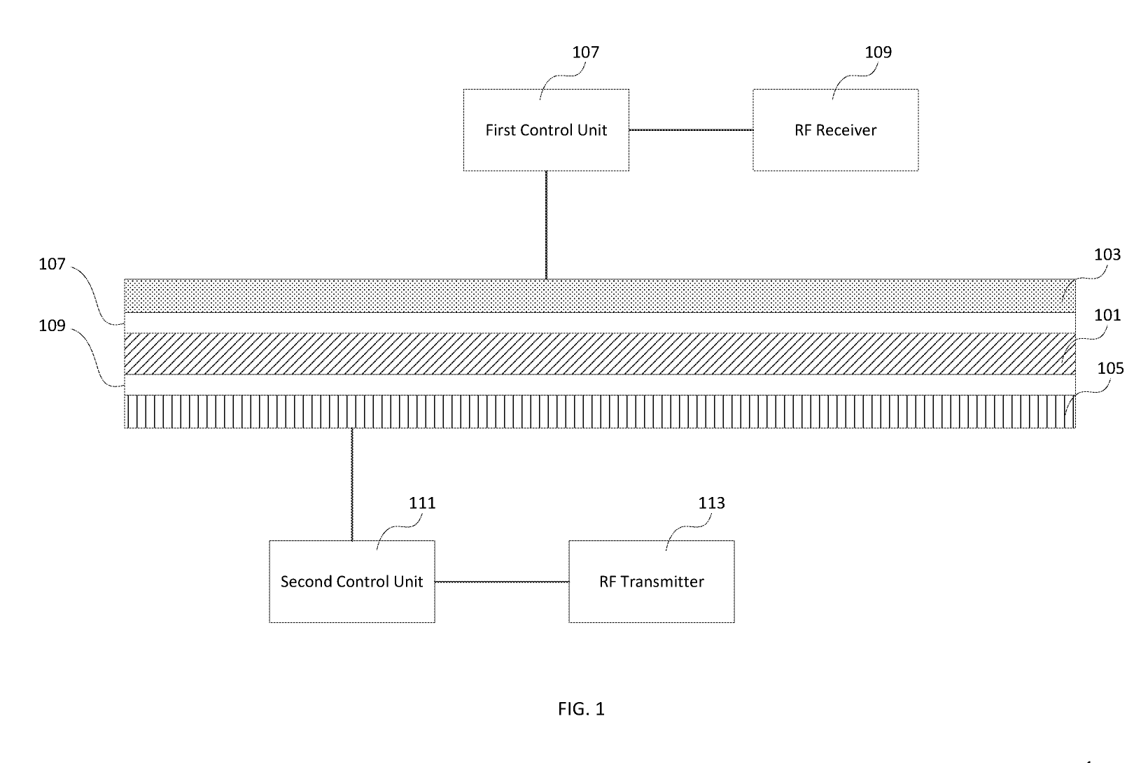

FIG. 1 is a block diagram of a wearable ultrasonic haptic feedback system in accordance with an embodiment of the present patent application. Referring to FIG. 1, the wearable ultrasonic haptic feedback system includes: a substrate layer 101; an ultrasonic transmitter matrix layer 103 disposed above the substrate layer 101; a converter matrix layer 105 disposed below the substrate layer 101; a first control unit 107 connected with the ultrasonic transmitter matrix layer 103; an RF receiver 109 connected with the first control unit 107; a second control unit 111 connected with the converter matrix layer 105; and an RF transmitter 113 connected with the second control unit 111.

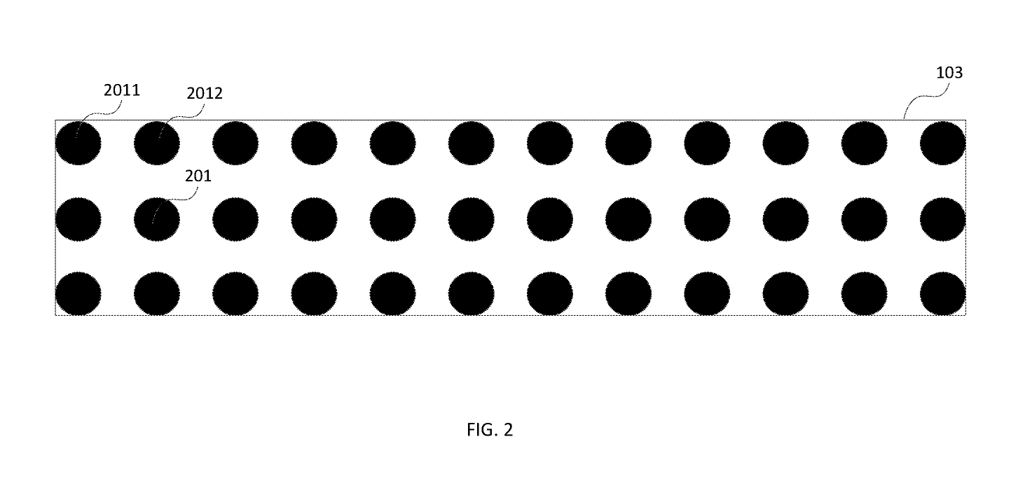

FIG. 2 illustrates the ultrasonic transmitter matrix layer 103 of the wearable ultrasonic haptic feedback system depicted in FIG. 1. Referring to FIG. 2, the ultrasonic transmitter matrix layer 103 includes a plurality of ultrasonic transmitters 201. The ultrasonic transmitters 201 are configured to be controlled by the first control unit 107 to transmit an ultrasonic signal of a preset frequency respectively.

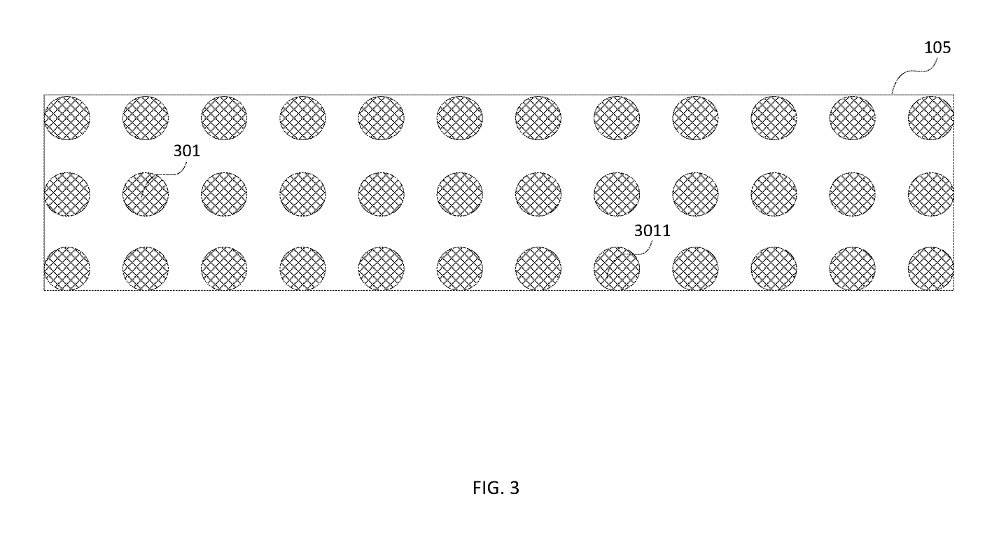

FIG. 3 illustrates the converter matrix layer 105 of the wearable ultrasonic haptic feedback system depicted in FIG. 1. Referring to FIG. 3, the converter matrix layer 105 includes a plurality of converters 301. The converters 301 are configured to be respectively controlled by the second control unit 111 to sense an ultrasonic signal and convert the sensed ultrasonic signal to an electrical signal. Referring to FIG. 1, the RF transmitter 113 is configured to transmit the electrical signal through an RF signal of a preset frequency. The RF receiver 109 is configured to receive the RF signal transmitted by the RF transmitter 113, and restore the electrical signal from the RF signal.

Referring to FIG. 1, FIG. 2 and FIG. 3, the second control unit 111 is configured to select any converter 3011 in the converter matrix layer 105 as a selected ultrasonic vibration feedback focus point (i.e. a selected converter). The first control unit 107 is configured to control a first ultrasonic transmitter 2011 in the ultrasonic transmitter matrix layer 103 to transmit a calibrating ultrasonic signal S1. The calibrating ultrasonic signal S1 is transmitted to the selected converter 3011 and sensed by the selected converter 3011 so as to produce a sensing electrical signal S1′. The sensing electrical signal S1′ is controlled by the second control unit 111, transmitted by the RF transmitter 113 in form of an RF signal, and received by the RF receiver 109. The first control unit 107 is configured to perform a time reversal transformation on the received signal S1′ and store an electrical signal waveform RS1 resulted from the transformation. Next, the first control unit 107 is configured to control a second ultrasonic transmitter 2012 in the ultrasonic transmitter matrix layer 103 to transmit a calibrating ultrasonic signal S2. The calibrating ultrasonic signal S2 is transmitted to the selected converter 3011 and sensed by the selected converter 3011 so as to produce a sensing electrical signal S2′. The sensing electrical signal S2′ is controlled by the second control unit 111, transmitted by the RF transmitter 113 in form of an RF signal, and received by the RF receiver 109. The first control unit 107 is configured to perform a time reversal transformation on the received signal S2′ and store an electrical signal waveform RS2 resulted from the transformation. The wearable ultrasonic haptic feedback system continues to repeat the above operations with other ultrasonic transmitters of the ultrasonic transmitter matrix layer 103, until all electrical signal waveforms corresponding to all ultrasonic transmitters of the ultrasonic transmitter matrix layer 103 are stored in the first control unit 107. Through the above processes, the wearable ultrasonic haptic feedback system completes automatic calibration and preparation for transmitting and focusing ultrasonic waves toward the selected ultrasonic vibration feedback focus point 3011.

It is noted that in the above calibration process, the calibrating ultrasonic signals S1, S2, and etc. being used for different ultrasonic transmitters may have the same strength or different strengths. For some locations at edges, the strength of the calibrating ultrasonic signals maybe enhanced so that the calibrating ultrasonic signals may be accurately sensed by the selected ultrasonic vibration feedback focus point 3011.

After the transformed electrical signal waveforms corresponding to all ultrasonic transmitters of the ultrasonic transmitter matrix layer 103 are stored in the first control unit 107, the first control unit 107 is configured to drive the ultrasonic transmitters simultaneously with the electrical signal waveforms that correspond to the ultrasonic transmitters respectively, so that the ultrasonic waves transmitted by the ultrasonic transmitters are focused at the selected ultrasonic vibration feedback focus point (i.e. the selected converter 3011's location) thereby generating haptic stimulation to the user. Preferably, the thickness of the converter matrix layer 105 is less than the thickness of the ultrasonic transmitter matrix layer 103, so as to make it easy for the user to feel the focus point of the ultrasonic waves.

In this embodiment, in the process of the calibrating ultrasonic signal S1 transmitting through the substrate layer 101 and being sensed by the selected converter 3011, the calibrating ultrasonic signal S1 will be unavoidably reflected, scattered and attenuated. As a result, the ultrasonic signal being actually sensed by the converter 3011 may be very different from the calibrating ultrasonic signal S1. However, when such ultrasonic signal being actually sensed is converted to electrical signal S′, and when the electrical signal S′ is transmitted to the first control unit 107, time reversal transformed, and used to drive the ultrasonic transmitter, based on the physical principle of time reversal of sonic waves, ultrasonic waves transmitted by different ultrasonic transmitters will be focused on the selected converter 3011.

In this embodiment, the wearable ultrasonic haptic feedback system may further include a display device (not shown in FIG. 1) connected with the first control unit 107 and configured to display the signal strength of signals received by the RF receiver 109. The signal is transmitted by the RF transmitter 113, representing the ultrasonic wave strength at the location of the selected converter 3011. After the calibration is completed, if the ultrasonic wave strength at the location of the selected converter 3011 is attenuated by a large amount, which may be caused by change of environment, user's operation, or other reasons, the haptic feedback for the user will be attenuated greatly. When this happens, the user is able to get confirmation from the readings of the display device. The system may also receive a preset threshold. When the ultrasonic wave strength at the location of the selected converter 3011 (i.e. the strength of the signal received by the RF receiver 109, or the signal strength displayed by the display device) is lower than the threshold, one or multiple above-mentioned automatic calibration operations will be reinitiated.

In this embodiment, the substrate layer 101 is made of a textile material with a certain thickness and structural strength. The wearable ultrasonic haptic feedback system further includes a first adhesive layer 107 and a second adhesive layer 109. The first adhesive layer 107 is disposed between the ultrasonic transmitter matrix layer 103 and the substrate layer 101 and configured to make the ultrasonic transmitter matrix layer 103 adhere to the substrate layer 101. The second adhesive layer 109 is disposed between the substrate layer 101 and the converter matrix layer 105 and configured to make the substrate layer 101 adhere to the converter matrix layer 105.

In this embodiment, the wearable ultrasonic haptic feedback system may further include a cover layer (not shown in FIG. 1). The cover layer covers the outside of the ultrasonic transmitter matrix layer 103 and the converter matrix layer 105. The RF transmitter 113 and the RF receiver 109 are respectively disposed at the surface of the converter matrix layer 105 and the surface of the ultrasonic transmitter matrix layer 103, and sealed by the cover layer. The cover layer is made of a material with strong capability of shielding EMI (Electromagnetic Interference) so as to prevent the RF communication between the RF transmitter 113 and the RF receiver 109 from being interfered by electromagnetic radiations surrounding the system.

In the wearable ultrasonic haptic feedback system provided by the above embodiments, the second control unit may further be connected with an external device, such as a computer or a game console, and configured to be controlled by the external device to select any converter in the converter matrix layer as the selected converter to receive the focused ultrasonic waves so as to generate a haptic stimulation that the user can feel and thereby realize haptic sensation feedback. When the calibrating ultrasonic signal is transmitted through the substrate layer and sensed by the selected converter, the ultrasonic signal being actually sensed by the selected converter includes spatial information related to the transmission media by which the ultrasonic signal travels as well as the shape and size of the converter itself. Such spatial information, in form of RF signals, is transmitted from the RF transmitter to the RF receiver, and is processed by the first control unit undergoing time reversal transformation so as to generate the driving signals required to focus the ultrasonic waves to the selected location. Because the transmission of RF signals is more accurate and stable than transmission of ultrasonic wave signals, the determination of the location of the ultrasonic wave focus point may be very accurate, and the resolution of the converters in the converter matrix layer may reach a relative high value, thereby realizing ultrasonic haptic feedback of high accuracy and high resolution. At the same time, the above wearable ultrasonic haptic feedback system may be conveniently integrated to apparel products such as gloves, clothes, decorative items, at a low cost, and therefore can be widely applied to various application scenarios.

While the present patent application has been shown and described with particular references to a number of embodiments thereof, it should be noted that various other changes or modifications may be made without departing from the scope of the present invention.

What is claimed is:

1. A wearable ultrasonic haptic feedback system comprising:
a substrate layer;
an ultrasonic transmitter matrix layer disposed above the substrate layer and comprising a plurality of ultrasonic transmitters;
a first adhesive layer disposed between the ultrasonic transmitter matrix layer and the substrate layer and configured to make the ultrasonic transmitter matrix layer adhere to the substrate layer;
a converter matrix layer disposed below the substrate layer and comprising a plurality of converters;
a second adhesive layer disposed between the substrate layer and the converter matrix layer and configured to make the substrate layer adhere to the converter matrix layer;
a first control unit connected with the ultrasonic transmitter matrix layer;
an RF receiver connected with the first control unit;
a second control unit connected with the converter matrix layer;
an RF transmitter connected with the second control unit;
a cover layer covering outside of the ultrasonic transmitter matrix layer and the converter matrix layer, the RF transmitter and the RF receiver being respectively disposed at surface of the converter matrix layer and surface of the ultrasonic transmitter matrix layer, and sealed by the cover layer, the cover layer being made of a material capable of shielding EMI; and
a display device connected with the first control unit and configured to display signal strength of signals received by the RF receiver; wherein:
thickness of the converter matrix layer is less than thickness of the ultrasonic transmitter matrix layer;
the ultrasonic transmitters are configured to be controlled by the first control unit to transmit an ultrasonic signal of a preset frequency respectively;
the converters are configured to be respectively controlled by the second control unit to sense an ultrasonic signal and convert the sensed ultrasonic signal to an electrical signal;
the RF transmitter is configured to transmit the electrical signal through an RF signal of a preset frequency;
the RF receiver is configured to receive the RF signal transmitted by the RF transmitter and restore the electrical signal from the RF signal;
the second control unit is configured to select any converter in the converter matrix layer as a selected converter;
the first control unit is configured to sequentially control each ultrasonic transmitter in the ultrasonic transmitter matrix layer to transmit a calibrating ultrasonic signal; the calibrating ultrasonic signal is transmitted to the selected converter and sensed thereby so as to produce a sensing electrical signal; the sensing electrical signal is controlled by the second control unit, transmitted by the RF transmitter in form of an RF signal, and received by the RF receiver; the first control unit is configured to perform a time reversal transformation on the sensing electrical signal received by the RF receiver and store an electrical signal waveform resulted from the transformation;
after the transformed electrical signal waveforms corresponding to all ultrasonic transmitters of the ultrasonic transmitter matrix layer are stored in the first control unit, the first control unit is configured to drive the ultrasonic transmitters simultaneously with the stored electrical signal waveforms that correspond to the ultrasonic transmitters respectively, so that ultrasonic waves transmitted by the ultrasonic transmitters are focused at the selected converter s location, thereby generating haptic stimulation to a user; and
when the signal strength displayed by the display device is lower than a preset threshold, the first control unit is configured to again sequentially control each ultrasonic transmitter in the ultrasonic transmitter matrix layer to transmit a calibrating ultrasonic signal; the calibrating ultrasonic signal is transmitted to the selected converter and sensed thereby so as to produce a sensing electrical signal; the sensing electrical signal is controlled by the second control unit, transmitted by the RF transmitter in form of an RF signal, and received by the RF receiver; the first control unit is configured to perform a time reversal transformation on the sensing electrical signal received by the RF receiver and store an electrical signal waveform resulted from the transformation.

2. A wearable ultrasonic haptic feedback system comprising:
a substrate layer;
an ultrasonic transmitter matrix layer disposed above the substrate layer and comprising a plurality of ultrasonic transmitters;
a converter matrix layer disposed below the substrate layer and comprising a plurality of converters;
a first control unit connected with the ultrasonic transmitter matrix layer;
an RF receiver connected with the first control unit;
a second control unit connected with the converter matrix layer; and
an RF transmitter connected with the second control unit; wherein:
the ultrasonic transmitters are configured to be controlled by the first control unit to transmit an ultrasonic signal of a preset frequency respectively;
the converters are configured to be respectively controlled by the second control unit to sense an ultrasonic signal and convert the sensed ultrasonic signal to an electrical signal;
the RF transmitter is configured to transmit the electrical signal through an RF signal of a preset frequency;
the RF receiver is configured to receive the RF signal transmitted by the RF transmitter and restore the electrical signal from the RF signal;
the second control unit is configured to select any converter in the converter matrix layer as a selected converter;
the first control unit is configured to sequentially control each ultrasonic transmitter in the ultrasonic transmitter matrix layer to transmit a calibrating ultrasonic signal; the calibrating ultrasonic signal is transmitted to the selected converter and sensed thereby so as to produce a sensing electrical signal; the sensing electrical signal is controlled by the second control unit, transmitted by the RF transmitter in form of an RF signal, and received by the RF receiver; the first control unit is configured to perform a time reversal transformation on the sensing electrical signal received by the RF receiver and store an electrical signal waveform resulted from the transformation; and
after the transformed electrical signal waveforms corresponding to all ultrasonic transmitters of the ultrasonic transmitter matrix layer are stored in the first control unit, the first control unit is configured to drive the ultrasonic transmitters simultaneously with the stored electrical signal waveforms that correspond to the ultrasonic transmitters respectively, so that ultrasonic waves transmitted by the ultrasonic transmitters are focused at the selected converter s location, thereby generating haptic stimulation to a user.

3. The wearable ultrasonic haptic feedback system of claim 2, wherein thickness of the converter matrix layer is less than thickness of the ultrasonic transmitter matrix layer.

4. The wearable ultrasonic haptic feedback system of claim 2, wherein the calibrating ultrasonic signals being used for different ultrasonic transmitters have the same strength.

5. The wearable ultrasonic haptic feedback system of claim 2, wherein the calibrating ultrasonic signals being used for different ultrasonic transmitters have different strengths.

6. The wearable ultrasonic haptic feedback system of claim 2 further comprising a display device connected with the first control unit and configured to display signal strength of signals received by the RF receiver.

7. The wearable ultrasonic haptic feedback system of claim 6, wherein when the signal strength displayed by the display device is lower than a preset threshold, the first control unit is configured to again sequentially control each ultrasonic transmitter in the ultrasonic transmitter matrix layer to transmit a calibrating ultrasonic signal; the calibrating ultrasonic signal is transmitted to the selected converter and sensed thereby so as to produce a sensing electrical signal; the sensing electrical signal is controlled by the second control unit, transmitted by the RF transmitter in form of an RF signal, and received by the RF receiver; the first control unit is configured to perform a time reversal transformation on the sensing electrical signal received by the RF receiver and store an electrical signal waveform resulted from the transformation.

8. The wearable ultrasonic haptic feedback system of claim 2, wherein when strength of signal received by the RF receiver is lower than a preset threshold, the first control unit is configured to again sequentially control each ultrasonic transmitter in the ultrasonic transmitter matrix layer to transmit a calibrating ultrasonic signal; the calibrating ultrasonic signal is transmitted to the selected converter and sensed thereby so as to produce a sensing electrical signal; the sensing electrical signal is controlled by the second control unit, transmitted by the RF transmitter in form of an RF signal, and received by the RF receiver; the first control unit is configured to perform a time reversal transformation on the sensing electrical signal received by the RF receiver and store an electrical signal waveform resulted from the transformation.

9. The wearable ultrasonic haptic feedback system of claim 2 further comprising a first adhesive layer and a second adhesive layer, wherein the substrate layer is made of a textile material with a certain thickness and structural strength; the first adhesive layer is disposed between the ultrasonic transmitter matrix layer and the substrate layer and configured to make the ultrasonic transmitter matrix layer adhere to the substrate layer; the second adhesive layer is disposed between the substrate layer and the converter matrix layer and configured to make the substrate layer adhere to the converter matrix layer.

10. The wearable ultrasonic haptic feedback system of claim 2 further comprising a cover layer covering outside of the ultrasonic transmitter matrix layer and the converter matrix layer, the RF transmitter and the RF receiver being respectively disposed at surface of the converter matrix layer and surface of the ultrasonic transmitter matrix layer, and sealed by the cover layer, the cover layer being made of a material capable of shielding EMI.

11. A wearable ultrasonic haptic feedback system comprising:
a substrate layer;
an ultrasonic transmitter matrix layer disposed above the substrate layer and comprising a plurality of ultrasonic transmitters;
a converter matrix layer disposed below the substrate layer and comprising a plurality of converters;
a first control unit connected with the ultrasonic transmitter matrix layer;
an RF receiver connected with the first control unit;
a second control unit connected with the converter matrix layer; and
an RF transmitter connected with the second control unit; wherein:
the ultrasonic transmitters are configured to be controlled by the first control unit to transmit an ultrasonic signal of a preset frequency respectively;
the converters are configured to be respectively controlled by the second control unit to sense an ultrasonic signal and convert the sensed ultrasonic signal to an electrical signal;
the RF transmitter is configured to transmit the electrical signal through an RF signal of a preset frequency; and
the RF receiver is configured to receive the RF signal transmitted by the RF transmitter and restore the electrical signal from the RF signal.

12. The wearable ultrasonic haptic feedback system of claim 11, wherein the second control unit is configured to select any converter in the converter matrix layer as a selected converter; the first control unit is configured to sequentially control each ultrasonic transmitter in the ultrasonic transmitter matrix layer to transmit a calibrating ultrasonic signal; the calibrating ultrasonic signal is transmitted to the selected converter and sensed thereby so as to produce a sensing electrical signal; the sensing electrical signal is controlled by the second control unit, transmitted by the RF transmitter in form of an RF signal, and received by the RF receiver; the first control unit is configured to perform a time reversal transformation on the sensing electrical signal received by the RF receiver and store an electrical signal waveform resulted from the transformation.

13. The wearable ultrasonic haptic feedback system of claim 12, wherein after the transformed electrical signal waveforms corresponding to all ultrasonic transmitters of the ultrasonic transmitter matrix layer are stored in the first control unit, the first control unit is configured to drive the ultrasonic transmitters simultaneously with the stored electrical signal waveforms that correspond to the ultrasonic transmitters respectively, so that ultrasonic waves transmitted by the ultrasonic transmitters are focused at the selected converter s location, thereby generating haptic stimulation to a user; thickness of the converter matrix layer is less than thickness of the ultrasonic transmitter matrix layer; the calibrating ultrasonic signals being used for different ultrasonic transmitters have the same strength.

14. The wearable ultrasonic haptic feedback system of claim 12, wherein the calibrating ultrasonic signals being used for different ultrasonic transmitters have different strengths.

15. The wearable ultrasonic haptic feedback system of claim 11 further comprising a display device connected with the first control unit and configured to display signal strength of signals received by the RF receiver.

16. The wearable ultrasonic haptic feedback system of claim 15, wherein when the signal strength displayed by the display device is lower than a preset threshold, the first control unit is configured to again sequentially control each ultrasonic transmitter in the ultrasonic transmitter matrix layer to transmit a calibrating ultrasonic signal; the calibrating ultrasonic signal is transmitted to the selected converter and sensed thereby so as to produce a sensing electrical signal; the sensing electrical signal is controlled by the second control unit, transmitted by the RF transmitter in form of an RF signal, and received by the RF receiver; the first control unit is configured to perform a time reversal transformation on the sensing electrical signal received by the RF receiver and store an electrical signal waveform resulted from the transformation.

17. The wearable ultrasonic haptic feedback system of claim 11, wherein when strength of signal received by the RF receiver is lower than a preset threshold, the first control unit is configured to again sequentially control each ultrasonic transmitter in the ultrasonic transmitter matrix layer to transmit a calibrating ultrasonic signal; the calibrating ultrasonic signal is transmitted to the selected converter and sensed thereby so as to produce a sensing electrical signal; the sensing electrical signal is controlled by the second control unit, transmitted by the RF transmitter in form of an RF signal, and received by the RF receiver; the first control unit is configured to perform a time reversal transformation on the sensing electrical signal received by the RF receiver and store an electrical signal waveform resulted from the transformation.

18. The wearable ultrasonic haptic feedback system of claim 11 further comprising a first adhesive layer and a second adhesive layer, wherein the substrate layer is made of a textile material with a certain thickness and structural strength; the first adhesive layer is disposed between the ultrasonic transmitter matrix layer and the substrate layer and configured to make the ultrasonic transmitter matrix layer adhere to the substrate layer; the second adhesive layer is disposed between the substrate layer and the converter matrix layer and configured to make the substrate layer adhere to the converter matrix layer.

19. The wearable ultrasonic haptic feedback system of claim 11 further comprising a cover layer covering outside of the ultrasonic transmitter matrix layer and the converter matrix layer, the RF transmitter and the RF receiver being respectively disposed at surface of the converter matrix layer and surface of the ultrasonic transmitter matrix layer, and sealed by the cover layer, the cover layer being made of a material capable of shielding EMI.

20. The wearable ultrasonic haptic feedback system of claim 11, wherein thickness of the converter matrix layer is less than thickness of the ultrasonic transmitter matrix layer.
